(19) United States
(12) Patent Application Publication
(10) Pub. No.: US 2007/0104212 A1
(43) Pub. Date: May 10, 2007

(54) Cache-based compression of structured network traffic

(76) Inventor: Michael Gutman, Zichron-Yaacov (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/270,935

(22) Filed: Nov. 10, 2005

(51) Int. Cl. H04L 12/54

(52) U.S. Cl. 370/428

(57) ABSTRACT

A method and apparatus for data compression of network traffic is provided. A cache is provided at each end of a communications communications link for storing control information that has been transmitted across the communications link. The caches maintain the same contents based on the same caching scheme allowing data to be compressed by transmitting an index to a cache entry storing control information instead of transmitting the control information.

### FIELD OF THE INVENTION

This disclosure relates to lossless compression and in particular to lossless compression of structured network traffic.

### BACKGROUND

A worm is a program that propagates itself across computers, usually by creating copies of itself in each computer's memory. With the widespread adoption of the Internet, the number worms and viruses that are propagated using e-mail have increased dramatically. One well-known e-mail worm is the Melissa worm. A copy of the Melissa worm is sent to the first 50 email address in a Microsoft Outlook address book, when an infected file is opened for the first time. Other well-known worms include the Code Red 2 worm which probes for machines based on subnet instead of randomly selected addresses and Nimba which is spread by using logically adjacent IP addresses in its scanning routines. Pattern matching methods for detecting worms are not sufficient to defend against worms because worms can spread faster than updates are created.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of an embodiment of a system for protecting against malicious attacks on the Internet;

FIG. 2 illustrates the format of an IP version 4 (IPv4) header included in a data packet received by the network controller;

FIG. 3 is a block diagram of an embodiment of the invention in which data compression is performed through the use of identical caches, one in the local area network controller and the other in the circuit breaker;

FIG. 4 is a flow diagram of an embodiment for managing cache in the transmit station at the transmit side of the communications link;

FIG. 5 is a flow diagram of an embodiment for managing cache in the receive station at the receive side of the communications link;

FIG. 6 is a block diagram of an embodiment of a direct mapped cache; and

FIG. 7 is a block diagram of an embodiment of a two-way set-associative cache.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

As the number of viruses, worms and attacks on the Internet increases, systems have been developed to protect against such attacks. Network awareness built into individual network controllers can be used to stop worm attacks at the first infected system. For example, novel worms may be detected by enabling each network controller device to intelligently monitor the health of its own network traffic. By looking for abnormalities in a range of system network behaviors the network controller device may be isolated from the network at the first sign of an attack. In this way, network controllers can form a last-line of defense against the spread of a worm.

Protection from viruses and worms can be provided by examining anomalies in packet traffic on a network. If an anomaly is detected from a particular computer, that computer is taken off the network. By examining changes in traffic pattern behavior instead of looking for particular viruses, for example, strings of characters in the traffic, false positives are avoided.

In order to protect against computer viruses and worms, the network controller monitors traffic (data packets) on the network to identify abnormal traffic. The monitoring of the network traffic involves analyzing various fields in a header of a packet. As the rate at which packets are received over a network increases, the rate at which control information in packet headers must be analyzed to detect an attack has also increased. The speed at which the packet data can be transferred for analysis becomes even more critical as the network speed increases to 10 Giga bits per second.

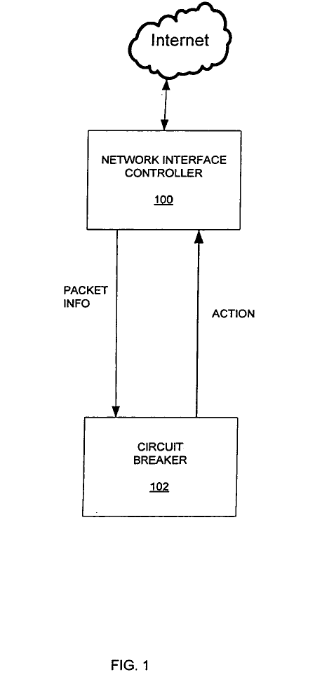

FIG. 1 is a block diagram of an embodiment of a system for protecting against malicious attacks on the Internet. The system includes a network interface controller 100, for example, a Local Area Network (LAN) device and a circuit breaker 102. The circuit breaker 102 provides a closed-loop mechanism, where packet information is sent from the network interface controller to a processing engine, where it is analyzed by a set of heuristics. The result of the analysis is a set of actions that are fed back to the network interface controller. The network interface controller then filters incoming and outgoing packets according to the actions programmed into it.

In one embodiment, a closed-loop mechanism is provided where packet information is sent from a network interface controller 100 over a communications link to a processing engine in the circuit breaker 102. The packet information that is sent to the processing engine is mostly repetitive, for example, all packet headers that belong to the same flow and therefore is efficiently compressed according to the principles of the present invention.

The processing of header data in packets received and transmitted by the network interface controller 100 may be performed by the circuit breaker 102 which may be coupled to the network interface controller 100. The rate at which information is forwarded over the communicatons link for analysis by the circuit breaker 102 may increase as the speed of the network increases. As the speed of the network increases to 10 Giga bits per second and greater, the communications link may not be able to handle the bandwidth requirements. Therefore, in order to handle the bandwidth requirements, the information may be compressed prior to forwarding it over the communications link.

Data compression refers to the process of reducing the amount of data needed to represent information. Data compression techniques reduce the costs for information storage and transmission and are used in many applications, ranging from simple file size reduction to speech and video encoding.

There are two different types of compression: lossless and lossy. In lossless compression, the source message at the encoder input is retrieved exactly at the output of the decoder. In lossy compression, the message is not retrieved exactly, but the information loss is tolerable for the type of application targeted by the compression schemes. Lossless compression techniques are used in applications where no information loss is tolerable.

Data may be received by the network interface controller over the network in the payload of a data packet. Each data packet includes a header that stores control information used to route the packet. This information includes the address of the source and destination of the packet. The header data is structured, with the structure typically defined by a standard network protocol. For example, Internet Protocol (IP) packets include an IP header that includes the IP source and IP destination addresses. The Internet Protocol standard is defined in the Internet Engineering Task Force (IETF) Request for Comments (RFC) 791.

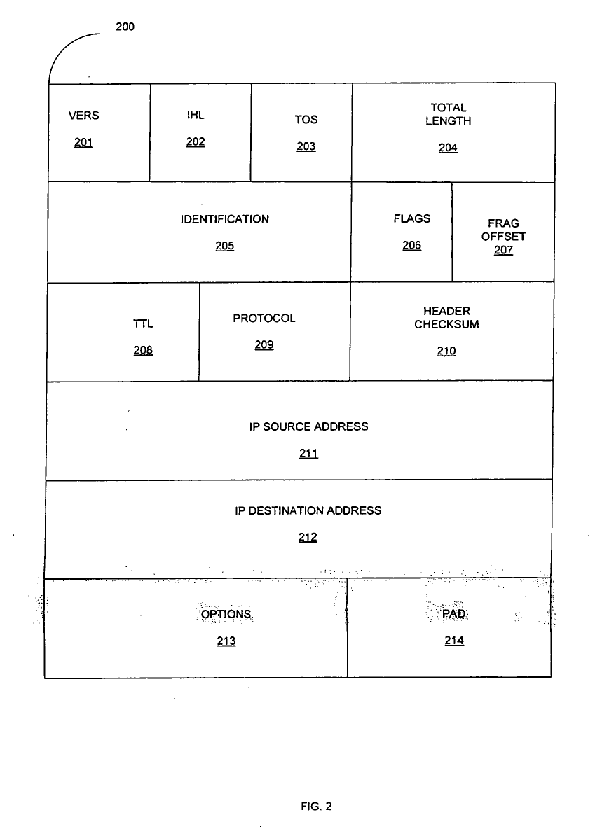

FIG. 2 illustrates the format of an IP version 4 (IPv4) header 200 included in a data packet received by the network device 100. The IP network layer header 200 includes a network address for the source, that is the IP source address 211, and a network address for the destination, that is, the IP destination address 212. Other fields in the IP network layer header 200 include Version 201, the IP header length (IHL) 202, Type of Service (TOS) 203, Total Length 204, Identification 205, Flags 206, Fragment Offset 207, Time to Live (“TTL”) 208, Protocol field 209, Header Checksum 210, Options 213 and pad 214.

The contents of the header may be mostly repetitive, for example, all packets that belong to the same IP flow have the same IP source address and IP destination address. Furthermore, each field in the header may be a fixed length, for example the IP source address in the IP header is 32-bits. Cache structures can be used to compress the structured repetitive information in the packet headers according to the principles of the present invention. Through the use of compression using cache lines, an effective mechanism is provided for transferring packet header data from the network interface device 100 to the processing agent in the circuit breaker.

Typically, each cache entry may store a number of words, known as a cache line or cache block and the entire cache line is read at one time. A cache line is the smallest unit of memory that can be accessed in a cache. For a memory cache used by a CPU to store a copy of the contents of main memory, this takes advantage of the principle of locality of reference, that is, if one location in main memory is read then following locations are likely to be read soon afterwards.

Typically, a node, for example, a client computer, communicates with a small number of other nodes. Thus, the addresses for the small number of nodes can be stored in a cache memory. When there is a miss, that is, an address is not stored in the cache, this address is then stored in the cache.

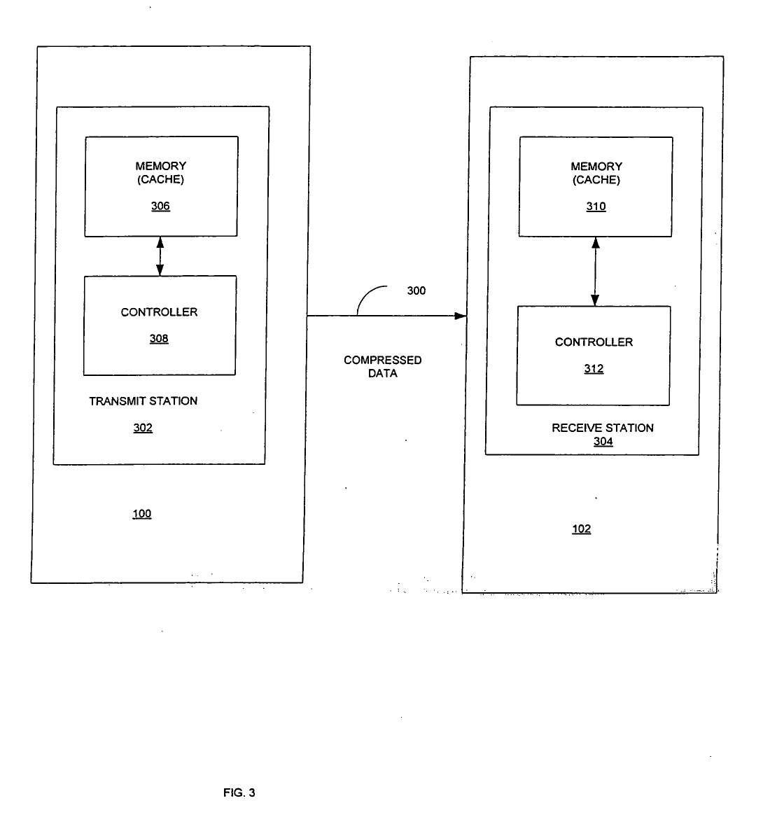

FIG. 3 is a block diagram of an embodiment of the invention in which data compression is performed through the use of identical caches, one accessible by the network interface controller 100 and the other accessible by the circuit breaker 102.

The cache is used to store a portion of possible values of the control information. For example, in the case of 32-bit control information, 232 locations are required to store all possible values. Instead of providing a memory for all possible values, a cache is used to store frequently received values of the control information. By storing these values in identical locations in both caches, an index to a cache line storing the input data can be transmitted across a communications link instead of the actual data to reduce data transferred across the communications link. The cache may be Synchronous Static Random Access Memory (SSRAM), Dynamic Random Access Memory (DRAM), Static Random Access Memory (SRAM), Content Addressable Memory (CAM) or another type of memory.

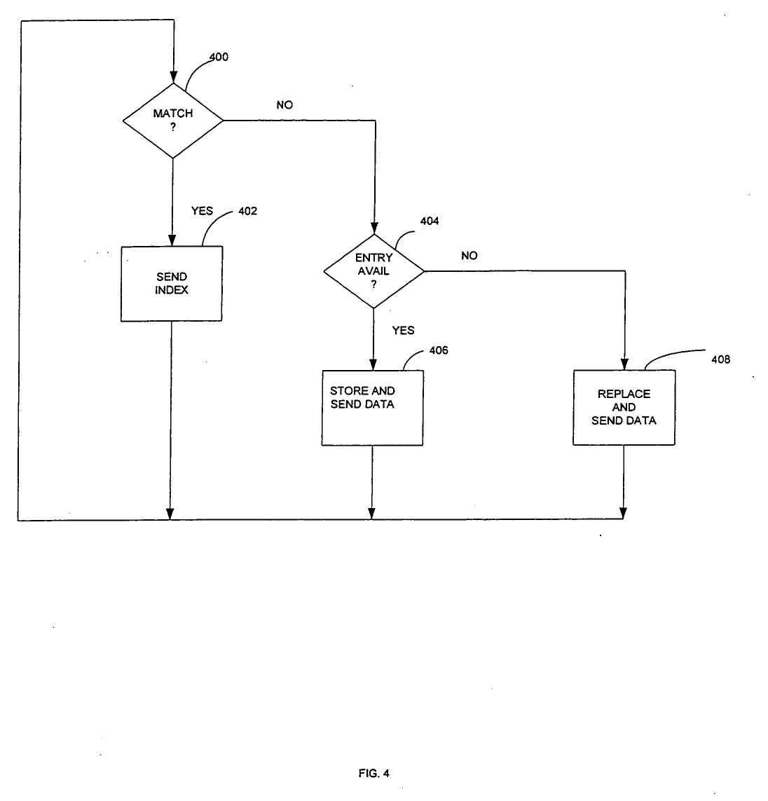

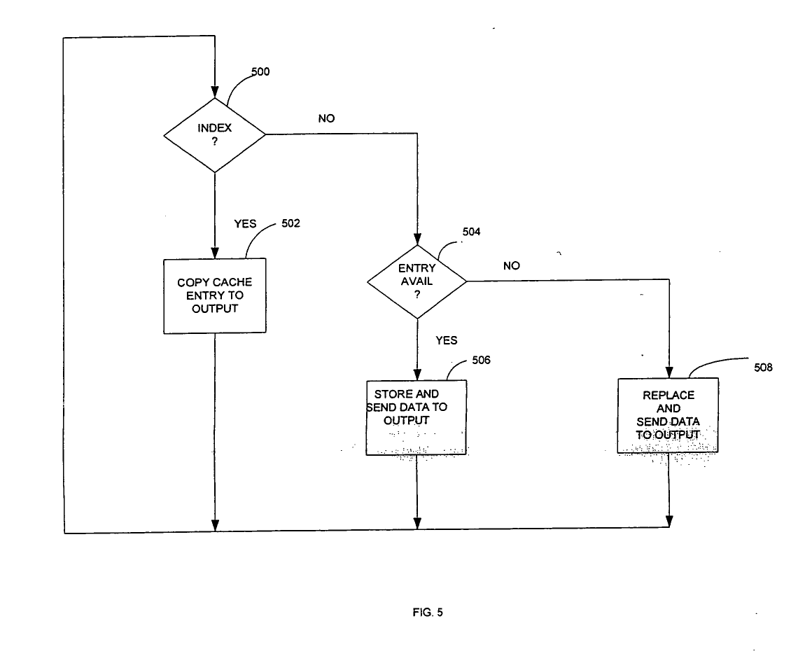

The network interface controller 100 may transmit compressed data over a communications link 300 to the circuit breaker 102. The network interface controller 100 may include a transmit station 302 that includes a transmit cache 306 and a controller 308. The circuit breaker 102 may include a receive station 304 that includes a receive cache 310 and a controller 312. With a cache 306, 310 at each of the two ends of the communications link 300 as shown in FIG. 3, the two caches maintain the same contents and are an exact copy of each other. A method for ensuring that each cache maintains the same contents will be described later in conjunction with FIGS. 4 and 5.

When the network interface controller 100 receives a packet from the network, it extracts information from the header of the packet. For example, in the case of the IP header 200 shown in FIG. 2, the network interface controller extracts the IP source address stored in the IP source address field 211 in the IP header 200. The network interface controller 100 checks to see if the IP source address is stored in its cache 306. If so, instead of sending the IP source address which may be 32-bits or 128-bits dependent on the version of IP, for example, IP version 4 (IPv4) or IP version 6 (IPv6), the network controller 102 sends an index (address) of the cache line in which the IP source address is stored in both caches. Thus, the IP source address is compressed by sending an index instead of the actual IP source address over the communications link 300 to the circuit breaker 102.

The compressed data is carried over the communications link using a link protocol. The communications link is a connection between the transmit station and the receive station that enables data transfer. The communications link may be dedicated to transmitting compressed data or may be shared with other traffic such as, network traffic. In an embodiment for a dedicated communications link, the communications link is unidirectional sending compressed data from the transmit station to the receive station. For example, a satellite link from a central station to remote receive stations. In an embodiment for a shared link, the communications link may be bi-directional. The compressed data may be sent over the communications link in parallel or serially, dependent on the type of link used. The communications link may be directly coupled through a wired link such as coaxial cable, twisted pair cable or optics between the receive station and the transmit station or may be a wireless link.

The link protocol may be to send the index together with a type indicating that an index is being transmitted instead of the control data (source address). For example, in an embodiment, the protocol used on the communications link can be:

<type = index> <index>
<type = control data> < control data>

In an embodiment with the type field having one bit, the type may be set to ‘0’ to indicate that an index is being sent and to ‘1’ to indicate that the control data, for example, the IP source address is being sent.

The controllers 308, 312 at each end of the link 300 cooperate and implement the same mechanism for selecting cache lines in the cache in which to store the control information. The controllers 308, 312 in the transmit station 302 and the receive station 304 use the same caching protocol for controlling their respective cache 306, 310 and thus the contents of each cache 306, 310 are identical. Since the receive cache 310 in the receive station 304 has the same entries as the transmit cache 306 in the transmit station 302, the receive station 304 can use the received index to retrieve the control information stored at that index in the cache 310.

The compression ratio of the communications link is dependent on the size of the cache and the hit rate. A larger cache provides a better hit rate but requires a bigger index. In an embodiment with a 16-bit index for 32-bit control data, the compression ratio is 2:1 for a received burst of packets, if the hit rate is 100%, that is, all of the control data received in a burst of packets is stored in the cache.

The effectiveness of the compression, that is, the compression ratio, is dependent on the hit rate in the cache. For example, if there are many packets with the same source address, the compression ratio is high because the source address is only forwarded over the communications link 300 the first time it is seen and the smaller index is sent the next times that the source address is seen in the packet header. The cache hit rate for applications that use structured information that is suitable for cache storage is high and provides good compression. For example, for network packet data with long lived bursty flows, the packet header data does not change frequently. Thus, a good compression ratio is provided, with same index sent for all of the packets in a burst.

Thus, control information that matches an entry in the cache need not be sent across the communications link 300 to the receive station 304. Instead, an index to the cache, indicating where the information is stored in both caches 306, 310 is transmitted providing a compression effect. Since the cache 310 in the receive station 304 stores an identical copy of the cache 306 in the transmit station 302, the received index is used to retrieve the corresponding data stored in the cache 310 at the receive side.

Each cache 306, 310 can be considered to be an array of M entries with each entry of size CacheLine bytes. Data to be sent over the communications link is broken into a section of cache line bytes and compared to entries stored in cache. Each input section is compared against N entries in the cache, where N can be any value in the range {1 . . ., CacheLine }.

FIG. 4 is a flow diagram of an embodiment for managing cache 306 in the transmit station 302 at the transmit side of the communications link 300.

At block 400, input data, for example, an IP source address is compared against N entries in the cache, where N can be any value in the range {1, . . . , CacheLine}. If the input data matches an existing cache entry among the N entries it is compared against, there is a hit in the cache and processing continues with block 402. If not, processing continues with block 404.

At block 402, an index representing the entry that matched in the transmit cache 306 is sent over the communications link. As the input data is already stored in the transmit cache, the cache is unmodified. Processing continues with block 400 to process the next input data.

At block 404, there was a miss in the transmit cache, the transmit cache is searched for an available entry in which to store the input data. If there is an empty entry, processing continues with block 406. If not, processing continues with block 408.

At block 406, there is at least one empty entry among the N entries. In this case (“line fill”), the new section is stored into the empty entry in the transmit cache and the input data is transmitted as is across the communications link. Processing continues with block 400 to process the next data to be transmitted over the communications link 300.

At block 408, all N entries for the input data are in currently in use. In this case, an entry is selected for replacement from the N cache entries, and the input data is stored in the selected entry. The input data is also transmitted as is across the communications link. Processing continues with block 400 to process the next data to be transmitted over the communications link 300.

FIG. 5 is a flow diagram of an embodiment for managing cache in the receive station 304 at the receive side of the communications link 300.

At block 500, if an index is received over the communications link 300, this indicates that there was a “hit” in the transmit cache 306 for the input data and that the input data is stored in an entry in the receive cache 310 at an entry corresponding to the index. Processing continues with block 502.

At block 502, the received index is used to select the entry, read the input data from the selected entry and forward the data for processing. As the input data is already stored in the receive cache 310, the cache is unmodified. Processing continues with block 500 to process the next data received over the communications link 300.

At block 504, there was a miss in the transmit cache 306, the receive cache 306 is searched for an available entry to store the input data using the same caching protocol used in the transmit station 302. If there is an empty entry, processing continues with block 506. If not, processing continues with block 508.

At block 506, there is at least one empty entry among the N entries. In this case (“line fill”), the input data is stored in the empty entry in the receive cache 310 and the received input data is forwarded for processing. Processing continues with block 500 to process the next input data received over the communications link 300.

At block 508, all N entries for the input data are currently in use. In this case, an entry is selected for replacement from the N cache entries in the receive cache 310, and the received input data is stored in the selected entry. The received input data is also forwarded for processing in the circuit breaker 102. Processing continues with block 500 to process the next input data or index.

The cache replacement and cache line fill stages described above are identical among the two caches 306, 310. Algorithms known to those skilled in the art of cache management can be used to manage both of the caches.

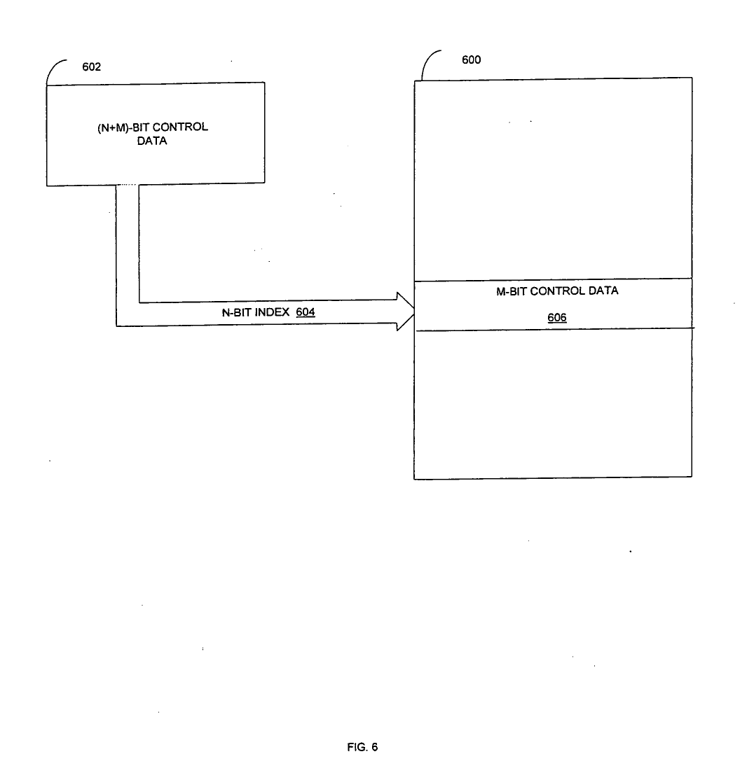

In one embodiment, both the receive cache 306 and the transmit cache 310 are direct mapped, that is, there is only one entry in the cache in which a particular input data can reside. FIG. 6 is a block diagram of an embodiment of a direct mapped cache. As shown in FIG. 6, n-bits of the (n+m) control data 602 is used to select an entry 606 in the cache 600 and the m bits of the control data is stored in the selected cache entry 606. For example, in an embodiment in which (n+m)=32, the control data is a 32-bit IP source address, the n=16 Most Significant bits are used to select an entry in the cache and the other (16-bits) of the IP source address is stored in the entry. For example, with input data of 1000AA55H, AA55H is stored in location 1000 in the cache. All input data with the 16 MSBs set to 1000 H shares the entry at location 1000 H in the cache. This only affects performance if there are continuous cache misses requiring replacing the entry in the cache. For example, if packets are received with different IP source addresses, each having the upper 16 MSBs set to 1000 H and thus all use the same entry in the cache.

In the embodiment with direct mapped cache, only one entry is selected based on n-bits of the input data, the data stored in the selected entry is read and compared with the remainder of the input data to determine if there is a match. If so, the n bits of the control data, that is, the index is forwarded over the communications link to the receive section 304 instead of all of the control data.

In another embodiment, the receive cache and transmit cache are fully associative. In contrast to a direct mapped cache, in a fully associative cache, the data can be stored anywhere in the cache and thus the entire cache is searched to find a matching entry for the input data. When the cache is full, in the case of a miss, a least recently used algorithm is typically used to determine an entry for storing the input data. The least recently used algorithm can replace the entry that has not been accessed for the longest time. A First In First Out algorithm may also be used, for example, to replace the entry that has been in the cache for the longest time. Alternatively, the entry to be replaced can be selected in a pseudo-random fashion such that the same replacement method is used to replace entries in both caches.

In a fully associative cache, the input data is typically used to access an associative memory which stores a plurality of tag entries. A tag entry is selected based on the input data and the index associated with the tag is used to select a cache line associated with the input data. If the cache line stores the input data, the index is sent over the communications link to the receive station 304 instead of the input data. In this case, when the cache is full, the same algorithm is used to select an entry to be replaced in both the transmit cache and the receive cache so that the contents of both caches remain the same. A fully-associative cache can be implemented using a Content Addressable Memory.

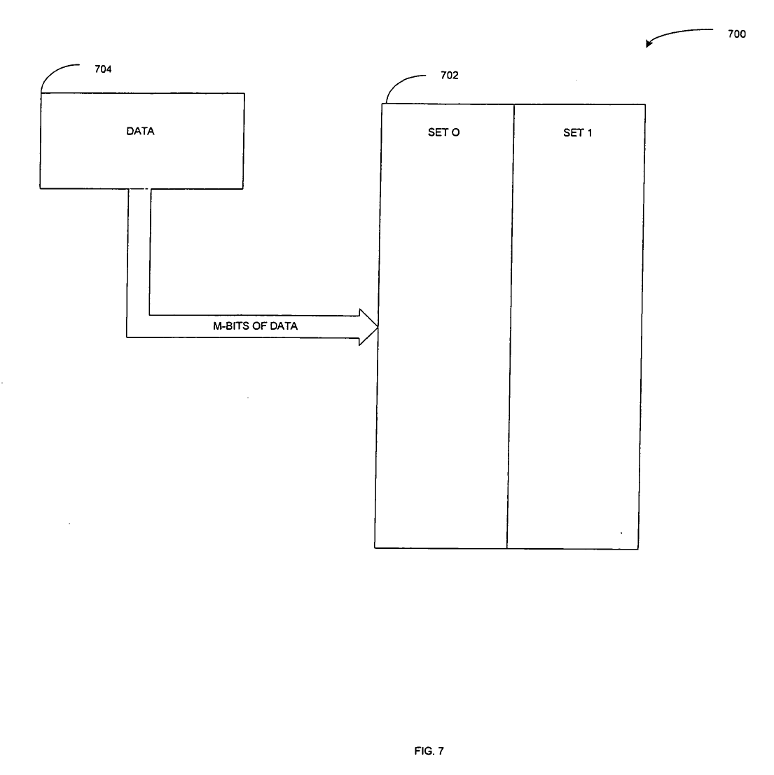

In yet another embodiment, the receive cache and transmit cache may be an n-way set-associative cache. In contrast to a fully associative cache, in which data can be stored in any entry in the cache, in an n-way set associative cache, there are n entries in which the data can be stored. A portion of the data is used to select the set, and the data can be stored in any entry in the set. FIG. 7 is a block diagram of an embodiment of a two-way associative cache 700.

In a 2-way set associative cache, there are two possible entries for each cache line one in each set and a cache line is selected based on a portion of the data. In the embodiment shown, there are n cache lines in the cache 702 and n is a power of 2, for example, n=2^{m}. The m Most Significant bits of the data are used to select one of the cache lines in the cache and the remaining bits are stored in the cache entry, either in set 0 or set 1. If the remaining bits of the data are not stored in either of the sets, there is a cache miss.

An embodiment for compressing IP source address has been described. IP source addresses are used to identify nodes communicating with the local node. For example, a local node such as a desktop computer typically communicates with a small number of nodes in a short interval time. Thus, if the node is suddenly communicating with a large number of nodes, this may signal a malicious attack. Other header fields may be used to detect a malicious attack such as the Level 4 protocol being used, for example, Transmission Control Protocol (TCP) and the TCP port numbers in a TCP header.

In another embodiment, each cache line (cache entry) can store data from more than one field in the structure. For example, referring to FIG. 2, for an IP header 200, the cache line can store the contents of the IP source address field 211, IP destination address field 212, the protocol field 209 and the header checksum field 210. In this case, the match between the input data that includes the contents of all these fields extracted from the IP header 200 and the cache line may be full or partial. In the case of a full match, the entire contents of the cache line match the input data and the index to the cache line is forwarded over the communications link 300 to the circuit breaker 102 as described previously.

In the case of a partial match, each sub-section in the input data is compared separately against the corresponding sub-section in the cache entry. In the case of one non-matching subsection in the input data, the input data is represented as the index to the cache entry plus the contents of the subsection in the input data that did not match. This new input data is not stored in the cache, instead the index of the cache entry plus the contents of the new subsection are forwarded. The receive station 304 reads the contents of the cache line located at the index in its cache and replaces the new subsection with the new contents that it received over the communications link. The contents of the cache line also include an indication of which subsections of the cache line matched. For example, in an embodiment with four subsections (sub-fields), each subsection may have a single bit with the value of the bit indicating whether the subsection matched.

Although an embodiment has been described for IP packet headers, the invention is not limited to IP packet headers. An embodiment of the invention can be used for efficient transmission of control information for a networking application. However, the invention is not limited to networking applications. For example, an embodiment of the invention can be used for inter-chip communications, for example, between a chipset and a graphics controller or for security appliances.

The data compression is fixed-length and block based. That is, both the data to be compressed and the compressed data are a fixed length based on the size of the cache and the size of the data to be compressed. Thus, the vocabulary (all possible cache lines) is fixed unlike other compression schemes that build the vocabulary adaptively based on an initial alphabet. However, the compression scheme of an embodiment of the invention is adaptive in its ability to store (in the cache) only a subset of the vocabulary that is being used

While embodiments of the invention has been particularly shown and described with references to embodiments thereof, it will be understood by those skilled in the art that various changes in form and details may be made therein without departing from the scope of the embodiments of the invention encompassed by the appended claims.

What is claimed is:

1. An apparatus comprising:
a controller to search a first memory for a match for control information and upon finding a match, to send an index over a communications link to indicate the location of the control information in the first memory, the control information stored in the same location in a second memory located at another end of the communications link.

2. The apparatus of claim 1, wherein upon not finding a match for the control information, the controller stores the control information in a location in the first memory and sends the control information over the communications link to be stored at the same location in the second memory by another controller.

3. The apparatus of claim 1, wherein upon finding a partial match for the control information in the first memory, the controller sends the index and a non-matching portion of the control information over the communications link.

4. The apparatus of claim 1, wherein the control information is received in a header of a data packet.

5. The apparatus of claim 1, wherein the first memory and the second memory are cache memory.

6. The apparatus of claim 5, wherein the cache memory is direct mapped.

7. The apparatus of claim 5, wherein the cache memory is fully associative.

8. A method for data compression comprising:
storing control information in a first memory;
searching the first memory for a match for control information; and
upon finding a match, sending an index over a communications link to indicate the location of the control information in the first memory, the control information being stored in the same location in a second memory located at another end of the communications link.

9. The method of claim 8, further comprising:
upon not finding a match for the control information, storing the control information in a location in the first memory and sending the control information over the communications link to be stored at the same location in the second memory by another controller.

10. The method of claim 9, further comprising:
upon finding a partial match for the control information in the first memory, sending the index and a non-matching portion of the control information over the communications link.

11. The method of claim 8, wherein the control information is received in a header of a data packet.

12. The method of claim 8, wherein the first memory and the second memory are cache memory.

13. The method of claim 11, wherein the cache memory is direct mapped.

14. The method of claim 12, wherein the cache memory is fully associative.

15. A system comprising:
a twisted pair cable;
a transmit station coupled to an end of the twisted pair cable, the transmit station comprising:
a first memory to store control information; and
a controller to search the first memory for a match for control information and upon finding a match, to send an index over the twisted pair cable to indicate the location of the control information in the first memory, the control information stored in the same location in a second memory located at another end of the twisted pair cable.

16. The system of claim 15, wherein upon not finding a match for the control information, the controller stores the control information in a location in the first memory and sends the control information over the twisted pair cable to be stored at the same location in the second memory by the second controller.

17. The system of claim 15, wherein upon finding a partial match for the control information in the first memory, the first controller sends the index and a non-matching portion of the control information over the twisted pair cable.

18. The system of claim 15, wherein the control information is received in a header of a data packet.

19. The system of claim 18, wherein the first and second memory are direct mapped cache memory.

20. The system of claim 19, wherein the first and second memory are fully-associative cache memory.
